(19) United States
(12) Patent Application Publication
(10) Pub. No.: US 2010/0207356 A1
(43) Pub. Date: Aug. 19, 2010

(54) TRAILER HITCH CONNECTOR

(75) Inventors: William T. Pottorff, Martinsville, IN (US); Steven L. Stroder, Martinsville, IN (US)

Correspondence Address: ICE MILLER LLP, ONE AMERICAN SQUARE, SUITE 3100, INDIANAPOLIS, IN, 46282-0200, US

(73) Assignee: XpandaHitch, LLC

(21) Appl. No.: 12/371,680

(22) Filed: Feb. 16, 2009

(51) Int. Cl. B60D 1/24

(52) U.S. Cl. 280/412

(57) ABSTRACT

A hitch connector for connecting a boat trailer to a follower trailer. The hitch connector comprises a trailer adapter configured to be attached to a rear portion of the boat trailer in an offset position from the longitudinal centerline of the boat trailer and a trailer extender configured to be secured to an end of the trailer adapter such that the trailer extender extends from the trailer adapter to beyond the rear portion of the boat trailer. In at least one embodiment, the trailer extender avoids the motor of a boat placed on the boat trailer at least partially because of the positioning of the trailer adapter.

### BACKGROUND

Trailers may be made to tow a motorcycle, car, boat, or the like behind a towing vehicle. In order to tow two trailers to a marina, storage place, or the like, it has been necessary to make separate trips for each trailer using a single towing vehicle. Alternatively, two vehicles may be used with each towing a trailer. Both scenarios are inefficient by wasting time, money, and energy. Accordingly, it is desired to provide a way of transporting multiple trailers simultaneously.

### SUMMARY

An aspect of the present disclosure comprises an apparatus for pulling a follower trailer behind a boat trailer. At least one embodiment of the apparatus comprises a trailer adapter configured to be attached to a rear portion of the boat trailer in an offset position from the longitudinal centerline of the boat trailer and at least one attachment assembly for attaching the trailer adapter on the rear portion of the boat trailer. At least one embodiment of the apparatus comprises a trailer extender configured to be secured to an end of the trailer adapter such that the trailer extender extends from the trailer adapter to beyond the rear portion of the boat trailer and, based at least partially upon the positioning of the trailer adapter, avoids the motor of a boat placed on the boat trailer and a securing assembly for securing the trailer extender to the trailer adapter.

An aspect of the present disclosure comprises an apparatus for transporting objects on trailers. At least one embodiment of the apparatus comprises a boat trailer comprising a trailer frame having multiple boat contact portions configured to receive the hull of a boat, multiple no-contact portions configured to at least support the boat contact portions, and at least two opposing wheels with at least one wheel on either side of the longitudinal centerline of the boat trailer. At least one embodiment of the apparatus comprises a follower trailer having a follower trailer frame, a tongue extending from a first portion of the follower trailer frame, and wheels on either side of the longitudinal centerline of the follower trailer. At least one embodiment of the apparatus comprises a hitch connector for connecting the boat trailer to the follower trailer. In at least one embodiment of the apparatus, the hitch connector comprises a trailer adapter configured to be attached to a rear portion of the boat trailer in an offset position from the longitudinal centerline of the boat trailer, at least one attachment assembly for attaching the trailer adapter on the rear portion of the boat trailer, a trailer extender configured to be secured to an end of the trailer adapter such that the trailer extender extends from the trailer adapter to beyond the rear portion of the boat trailer and based at least partially upon the positioning of the trailer adapter avoids the motor of a boat placed on the boat trailer, and a securing assembly for securing the trailer extender to the trailer adapter.

An aspect of the present disclosure comprises a method of securing a boat trailer to a follower trailer. At least one embodiment of the method comprises providing a hitch connector having a trailer adapter configured to be attached to a rear portion of the boat trailer in an offset position from the longitudinal centerline of the boat trailer, at least one attachment assembly for attaching the trailer adapter on the rear portion of the boat trailer, a trailer extender configured to be secured to an end of the trailer adapter such that the trailer extender extends from the trailer adapter to beyond the rear portion of the boat trailer and based at least partially upon the positioning of the trailer adapter avoids the motor of a boat placed on the boat trailer, and a securing assembly for securing the trailer extender to the trailer adapter. At least one embodiment of the method comprises attaching the trailer adapter to the boat trailer in an offset position from the longitudinal centerline of the boat trailer, attaching the trailer extender to the trailer adapter, wherein the extender extends out from the rear of the boat trailer, and attaching a follower trailer to the trailer extender.

### BRIEF DESCRIPTION OF THE DRAWINGS

The features and advantages of this disclosure, and the manner of attaining them, will be more apparent and better understood by reference to the following descriptions of the disclosed methods and systems, taken in conjunction with the accompanying drawings, wherein:

FIG. 1 shows a side view of an apparatus for pulling a follower trailer behind a boat trailer according to at least one embodiment of the present disclosure.

FIG. 2a shows a perspective view of a hitch connector according to at least one embodiment of the present disclosure.

FIG. 2b shows a perspective, exploded view of a housing and a trailer adapter according to at least one embodiment of the present invention.

FIG. 3 shows a perspective view of a hitch connector attached to a boat trailer according to at least one embodiment of the present disclosure.

FIG. 4a shows a hitch connector connecting a boat trailer to a follower trailer according to at least one embodiment of the present disclosure.

FIG. 4b shows the top view of the hitch connector connecting a boat trailer to a follower trailer of FIG. 4a according to at least one embodiment of the present disclosure.

FIG. 5a shows a side view of an extrapter according to at least one embodiment of the present disclosure.

FIG. 5b shows a side view of a hitch connector and an extrapter according to at least one embodiment of the present disclosure.

FIG. 5c shows a side view of an extrapter attached to a hitch connector according to at least one embodiment of the present disclosure.

FIG. 6a shows a side view of a hitch connector with two extrapters attached thereto according to at least one embodiment of the present disclosure.

FIG. 6b shows a side view of the hitch connector with two extrapters of FIG. 6a and an attachment assembly with a housing according to at least one embodiment of the present disclosure.

FIG. 6c shows a side view of the hitch connector with two extrapters of FIG. 6a with an attachment assembly attached to an extrapter according to at least one embodiment of the present disclosure.

FIG. 7 shows a flowchart of a method of securing a boat trailer to a follower trailer according to at least one embodiment of the present disclosure.

### DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

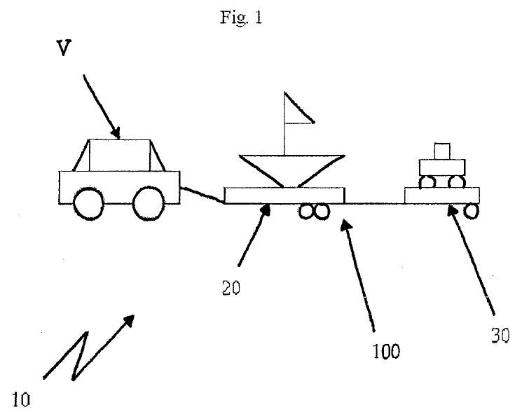

The present disclosure provides a method and apparatus for towing two or more trailers at the same time using one vehicle. FIG. 1 shows a perspective view of an apparatus 10 for pulling a follower trailer 30 behind a boat trailer 20. A boat trailer 20 may generally be any type of trailer for boats but typically includes a trailer having a frame with longitudinal beams and at least one traverse beam. A follower trailer 30 may be any type of trailer but typically includes a trailer that is smaller in size compared to the boat trailer 20. For example, the follower trailer may be a jet ski trailer, motorcycle trailer, ATV trailer, or the like. As shown in FIG. 1, the apparatus 10 may be used with a vehicle V that pulls the boat trailer 20 and follower trailer 30 according to at least one embodiment of the disclosure. The boat trailer 20 and follower trailer 30 are connected using a hitch connector 100 which is mounted on the boat trailer 20. The hitch connector 100 allows for the boat trailer 20 and follower trailer 30 to be towed simultaneously by one vehicle V.

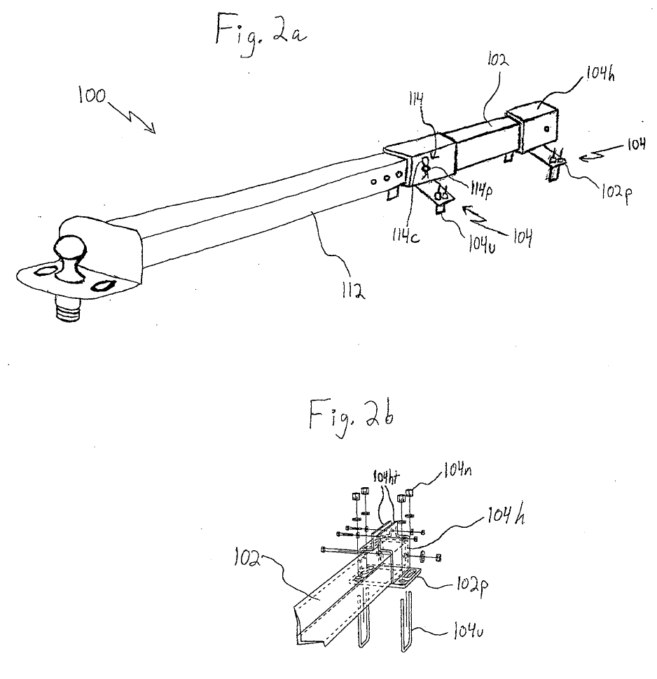

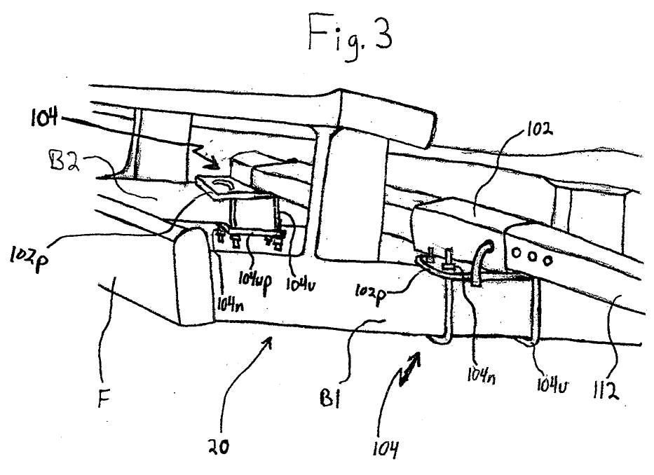

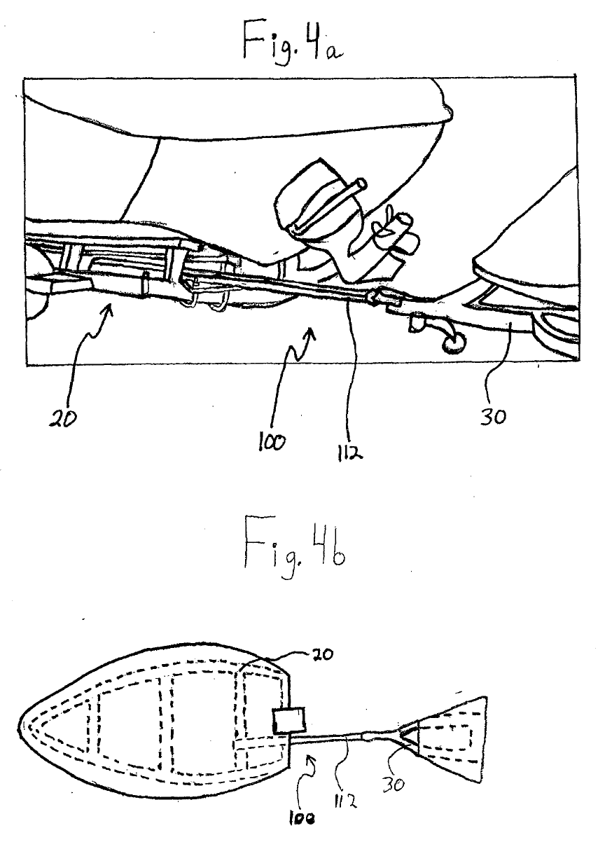

As shown in FIG. 2a, the hitch connector 100 comprises a trailer adapter 102 for mounting on the frame of a boat trailer 20, attachment assemblies 104 for securing the trailer adapter 102 to the boat trailer 20, a trailer extender 112 for connecting the hitch connector 100 to the follower trailer 30, and a securing assembly 114 for attaching the trailer adapter 102 to the trailer extender 112. The trailer adapter 102 is configured to attach to the frame of most types of boat trailers, such as trailer frames with both longitudinal and traverse beams. In particular, the trailer adapter 102 may be mountable on traverse cross members of the frame of a boat trailer 20. As shown in FIG. 3, the trailer adapter 102 is attached to beams B1,B2 of the frame F of the boat trailer 20 using attachment assemblies 104. In at least one embodiment of the present disclosure, the trailer adapter 102 is removably mountable on the boat trailer frame. Of course, trailer adapters 102 may be permanently mounted or the like to boat trailer frames.

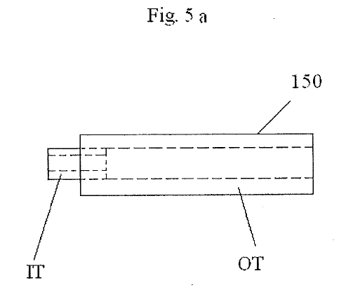

The trailer adapter 102 is typically attached to a trailer frame in a position that is offset from the longitudinal centerline of the trailer frame. By offsetting the positioning of the adapter 102 relative to the longitudinal centerline of the trailer frame, the hitch connector 100 is able to avoid obstructions presented by boat motors, thereby allowing the hitch connector 100 to link up with a follower trailer 30. For example, FIGS. 4a and 4b show a hitch connector 100 that is attached to the boat trailer 20 in a position that is offset from the longitudinal centerline of the boat trailer 20. Accordingly, as clearly shown in FIG. 4b, the hitch connector 100 avoids the boat motor at least partially because of the positioning of the hitch connector 100 on the boat trailer 20.

The trailer adapter 102 is typically a hollow, elongated structure having a rectangular or square cross section but it may have other shapes. The trailer adapter 102 may be various sizes and lengths, including a 3 inch by 3 inch square cross-section with 0.25 inch thick walls that is 60 inches long. The trailer adapter 102 may have various apertures for receiving bolts, pins, or similar to secure the trailer extender 112, housing 104h, or the like thereto. The apertures may include a 0.75 diameter hole that is 2.38 inches from the front edge of the trailer adapter 102 and 1.5 inches from the bottom edge of the trailer adapter 102. Another aperture in the trailer adapter 102 may be located 0.38 inches from the rear edge of the trailer adapter 102 and 1.5 inches from the bottom edge of the trailer adapter 102 and may have a 0.44 inch diameter. Generally, the trailer adapter 102 is metal, such as steel, or another material that provides a rigid, strong structure. As shown in FIG. 2a, a plate 102p may be attached to the trailer adapter 102 along an edge of the trailer adapter 102. Alternatively, as discussed below, the plate 102p may be part of an attachment assembly 104.

The plate 102p may generally lay flat on the top side of a traverse beam of a boat trailer frame, such as beams B1,B2 of FIG. 3. In order to accommodate sloping frames or otherwise non-parallel frames, particularly across traverse beams, wedges or similar devices may be used to support portions of the plate 102p. For instance, a plastic wedge may be inserted underneath a portion of a plate 102p that has space between its bottom surface and the trailer beam or a plate 102p that is not substantially parallel with the ground. The empty space between a plate 102p and trailer frame or non-parallel orientation of a plate 102p may be unstable or otherwise provide an undesirable position and orientation of a hitch ball located on end of the trailer extender 112. Wedges may be designed to match the given slope of each trailer frame such that the trailer adapter 102 may be more easily and properly attached to the trailer frame. The wedges may include attachment devices, such as snap connectors, hook and loop fasteners, or the like, that allow for the wedges to be secured to the trailer frame, plate 102p, or both. In addition or alternatively, a wedge may be secured to the plate 102p and/or the trailer frame using a bolt and nut, pin and clip, or the like. The plate 102p and wedge device may include apertures that, for example, are about ⅝ inch and that, when aligned, may receive a threaded bolt. When tightened within the plate 102p and wedge device, the threaded bolt may secure the plate 102p and wedge device together. As mentioned above, the bolt or the like may also pass through or engage the trailer frame, such as through an aperture in the trailer frame. It should also be noted that, by tightening or adjusting the U-bolts (discussed below), the wedge device may be at least partially trapped between the plate 102p and trailer frame such that the wedge device is substantially immovable relative to the plate 102p and trailer frame. In any case, a wedge device or the like may be secured or trapped between a portion of the plate 102p and the trailer frame to provide a desired orientation of the hitch connector (e.g., substantially parallel with the ground). The wedge device or the like may be various shapes and sizes, such as a triangular cross-section or the like. The wedge device or the like may be various materials including metal, rubber, or the like and may include gripping surfaces that resist movement while in contact with the plate 102p and/or trailer frame. The plate 102p may be various shapes and sizes, such as a 6 inch by 6 inch square with a 0.25 inch thickness, 0.38 inch thickness, or the like. Furthermore, the plate 102p may have two or more 0.69 inch diameter apertures that are located 1.13 inches from the front edge of the plate 102p and 0.75 inches from a side edge of the plate 102p for receiving, for example, an edge of a U-shaped bolt 104u. The plate 102p may also include pill-shaped apertures defined by two 0.34 inch radius circles and lines connecting the circles, where the apertures are about 3 inches long. An edge of a pill-shaped aperture may be about 0.5 inches from the rear edge of the plate 102p. The pill-shaped aperture may also receive, for instance, an edge of a U-shaped bolt 104u.

As mentioned above, attachment assemblies 104 are used to attach the trailer adapter 102 to the frame of a trailer. The attachment assemblies 104 may include various devices for securing the adapter 102 to the trailer frame. An attachment assembly 104 may include a housing 104h that is configured to fit over and attach to the trailer adapter 102, where a bolt and nut, pin and clip, or the like may be used for attaching the housing 104h to the trailer adapter 102. Typically, the housing 104h may be a tube with a rectangular cross-section having dimensions substantially similar to the trailer adapter 102 but larger thereby allowing for the housing 104h to fit over the trailer adapter 102. See, for example, FIG. 2a. In one embodiment of the invention, as shown in FIG. 2b, a housing 104h may have an open neck between two tabs 104ht. The tabs 104ht may be a 6 inch long by 3/16 inch piece of steel or the like that has been machined to fit around the trailer adapter 102. As shown in FIG. 2b, the tabs 104ht may be shaped to have a substantially perpendicular bend at a distance up from the plate 102p, such as 3.5 inches up from the plate 102p. After the first bend, the tab 104ht may run substantially parallel with the surface of the plate 102p 1.31 inches or the like until the second bend, which directs the tab 104ht perpendicular to and upward from the plate 102p. The tab 104ht may contain an aperture about 1.5 inches up from the plate 102p and 0.59 inches from an edge of the tab 104ht, which may be used to secure the housing 104h to the trailer adapter 102. By applying bolts, washers, and nuts, the neck defined as the space between the tabs 104ht may be narrowed or substantially eliminated by bringing the tabs 104ht together. For example, apertures on the tabs 104ht with 0.25 inch diameters may be positioned 1.63 inches from the front or rear edge of the tabs 104ht. Bolts that are 3/16 inches in diameter and 1.5 inches long, washers that are 3/16 inches in diameter, and nuts having 3/16 inches diameter may be applied to the apertures on the tabs 104ht to secure the tabs 104ht together or near each other. Similar to the trailer adapter 102, the housing 104h may be formed of metal (e.g., steel), plastic, or the like.

An attachment assembly 104 may be positioned anywhere along the trailer adapter 102 to accommodate varying distances between beams of the frame of the trailer. As shown in FIGS. 2a and 2b, a housing 104h is attached to an end of the trailer adapter 102 but may be attached anywhere between the ends of the trailer adapter 102. Bolts that are 5/16 inch diameter by 4.25 inches long may be used with a washer having a 0.5 inch diameter and a 5/16 inch hex nut to secure the housing 104h to the trailer adapter 102. Of course, the housing 104h may simply be a part of the trailer adapter 102, instead of the attachment assembly 104. In other words, the trailer adapter 102 may be formed as a single piece with portions thereof having similar structure to the housing 104h. As discussed below, attachment assemblies 104 with housings 104h may be attached to extrapters 150 or other devices used to extend the length of a trailer adapter 102. The attachment assemblies 104 that are attached to the extrapters 150 may be used to secure the trailer adapter 102 (via the extrapter 150) to a beam of the trailer frame.

Also, an attachment assembly 104 typically includes U-shaped bolts 104u or the like that are generally sized to at least partially straddle the beams of the boat trailer frame. The thickness of the U-shaped bolts 104u may be 0.25 inches in diameter. As shown in FIG. 3, the ends of the U-shaped bolts 104u may be placed through apertures in the plate 102p and positioned such that the U-shaped bolts 104u straddle the beam B1,B2. In order to lock the U-shaped bolts 104u in place and the trailer adapter 102 against the boat trailer frame, a washer plate 104wp and nuts 104n may be used. See, for example, the attachment assembly secured to beam B2. The washer plate 104wp is typically square or rectangular shaped and includes apertures sized to receive ends of the U-shaped bolts 104u. The washer plate 104wp may be plastic, metal (e.g., steel), or other material. As shown in FIG. 3, the washer plate 104wp is positioned on the bottom side of beam B2 of the boat trailer frame (e.g., opposite the plate 102p) with portions of the U-shaped bolts 104u passing through its apertures. The nuts 104n may be tightened on the ends of the U-shaped bolts 104u in order to hold the attachment assembly in position and lock the trailer adapter 102 against the beam B2. Accordingly, the washer plate 104wp, U-shaped bolts 104u, and nuts 104n effectively act to clamp the trailer adapter 102 to the frame of the boat trailer 20. Accordingly, the trailer adapter 102 is substantially attached to the frame. Alternatively and also shown in FIG. 3, nuts 104n may be used without the washer plate 104wp. As shown in FIG. 3, an attachment assembly 104 secures the trailer adapter 102 to beam B1. The plate 102p lays flat on beam B1 of the frame while the U-shaped bolts 104u straddle beam B1 with the ends of the U-shaped bolts 104u pointing up through apertures in the plate 102p. Nuts 104n may then be tightened on the ends of the U-shaped bolts 104u in order to secure the corresponding attachment assembly 104 to the frame. The nuts may have a 0.25 inch diameter or the like. Of course, washers may be used along with the nuts 104n, such as 0.25 inch split lock washers or the like, to secure the U-shaped bolts 104u to the trailer frame, thereby substantially attaching the trailer adapter 102 to the trailer frame. Typically, the trailer adapter 102 is secured or clamped to two separate traverse beams of the frame. See, for example, FIG. 3. By securing the trailer adapter 102 to two beams of the frame, the adapter 102 may be substantially unable to rotate or otherwise move.

The trailer extender 112 is configured to be secured to the trailer adapter 102 such that it extends from an end of the trailer adapter 102 to beyond the rear portion of the boat trailer 20. As mentioned above, based at least partially upon the positioning and orientation of the trailer adapter 102 with respect to the trailer frame, the trailer extender 112 may avoid the motor of a boat placed on the boat trailer 20. In other words, the trailer extender 112 may extend from the trailer adapter 102 to a position clear of the trailer and boat (including the motor) so that the tongue of the follower trailer 30 may be attached to the extender 112. In FIGS. 4a and 4b, a trailer extender 112 is shown extending past a trailer and clear of a boat's motor and attached to a follower trailer. Accordingly, by offsetting the positioning of the adapter 102 relative to the longitudinal centerline of the trailer frame, the hitch connector 100 is able to avoid obstructions, such as those presented by boat motors, and attach to a follower trailer.

The trailer extender 112 is typically a hollow, elongated structure having a rectangular or square cross section but it may have other shapes, such as a circular cross-section. The trailer extender 112 may have a square cross-section that is 2.5 inches by 2.5 inches and a length of 53.75 inches. The thickness of the walls of the trailer extender 112 may be 0.25 inches. Of course, the trailer extender 112 may have other sizes and shapes. A trailer extender 112 is generally sized to fit within the trailer adapter 102. For example, in FIG. 2a, the trailer extender 112 is shown partially received within the trailer adapter 102. The trailer extender 112 may be translated within and with respect to the trailer adapter 102 along a shared longitudinal axis. For instance, when the hitch connector is not needed, such as when only using the boat trailer, the trailer extender 112 may be secured substantially within the trailer adapter 102 such that the trailer extender 112 does not extend beyond the back of the trailer or beyond the boat.

As discussed below, the trailer extender 112 may also include a hitch ball at one end. The hitch ball may be any type and size, including a 2 inch hitch ball. The hitch ball may be attached to a shank, which may be 1 inch in length. In order to secure the hitch ball to the trailer extender 112 or to an angled plate that is attached to the trailer extender 112, the shank may be inserted into an aperture of the trailer extender 112 or angled plate and secured thereto using a shank washer and shank nut. The shank washer may be a 1 inch washer while the shank nut may be a 1 inch nut. Of course, other sizes and shapes of hitch ball, angled plate, washer, and bolt may be used. Generally, the trailer extender 112 is metal (e.g., steel) or another material that provides a rigid, strong structure.

The trailer extender 112 is generally secured to the trailer adapter 102 by way of the securing assembly 114. Typically, the securing assembly 114 will include pins 114p and clips 114c. The securing assembly 114 may be various types of devices and systems that hold two objects together. Also, the trailer extender 112 may be modified so as to accommodate such securing devices. For example, along the length of the trailer extender 112, there may typically be apertures that pass completely through the trailer extender 112. Similarly, the trailer adapter 102 typically may include apertures that pass completely through the trailer adapter 102. The apertures may be any size and shape, such as a 0.75 diameter circle or the like. The apertures along the trailer extender 112 may be spaced by various lengths, such as 3 feet 5 inches from each other and 7 inches from the end of the trailer extender 112. By adjusting the position of the trailer extender 112 relative to the trailer adapter 102, the corresponding apertures may be aligned. As shown in FIG. 2a, pin 114p may be fitted through aligned apertures and a clip 114c may be applied to the pin 114p to restrict the pin 114p from coming out of the aligned apertures. Accordingly, the pin 114p and clip 114c may lock the trailer extender 112 in place relative to the trailer adapter 102. By adjusting the position of the trailer extender 112 relative to the trailer adapter 102 and securing the pin 114p and clip 114c within aligned apertures along the trailer adapter and extender, the length of extension of the trailer extender 112 relative to the trailer adapter 102 may be increased or decreased.

With the trailer extender 112 attached to the trailer adapter 102 and extending out beyond the rear of the boat trailer, the tongue of the follower trailer 30 may be attached to the end of the trailer extender 112. For example, the tongue may be secured to a hitch ball positioned on the end of the trailer extender 112.

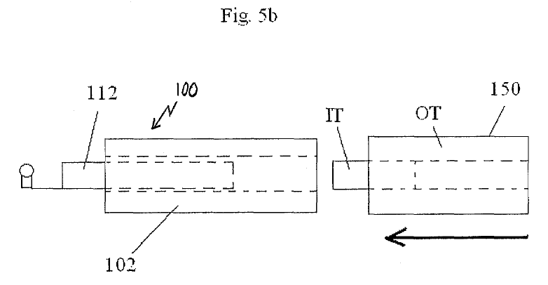

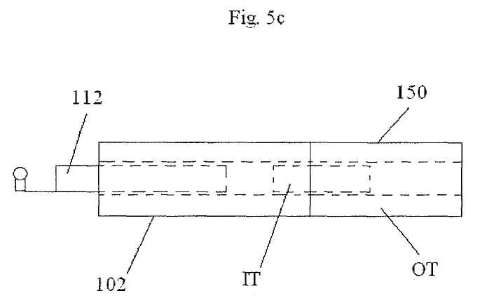

In one embodiment of the present disclosure an extrapter 150 may be secured to an end of the trailer adapter 102. The extrapter 150 may provide extra length for the hitch connector 100 so as to enable attaching the hitch connector 100 to traverse cross members of the frame of the boat trailer 20 or a traverse cross member and an end portion of the frame that are separated by a distance greater than the length of the trailer adapter 102. Of course, multiple extrapters 150 may be secured end-to-end to provide the needed length to connect the hitch connector to traverse cross members. Extrapters 150 may be 24.25 inches long or the like. Extrapters 150 may have various configurations and be comprised of a variety of materials, such as metal (e.g., steel), plastic, or another material that provides a rigid, strong structure. In FIG. 5a, an extrapter 150 is shown comprising two concentric tubes IT,OT. The tubes IT,OT may have rectangular cross sections, square cross sections, circular cross sections, or the like. The outer tube OT may generally have the same cross-sectional dimensions as the cross section of the trailer adapter 102, while the inner tube IT may generally have cross-sectional dimensions that are scaled down from the cross section of the trailer adapter 102 such that the inner tube IT may fit within the hollow interior of the trailer adapter 102. In order to facilitate insertion of the inner tube IT into the trailer adapter 102, the cross-sectional shape of the inner tube IT may have the same cross-sectional shape and substantially similar size as the hollow interior surface of the trailer adapter 102. For example, the inner tube IT and hollow interior surface of the trailer adapter 102 may both have rectangular cross-sections. The outer tube OT may have, for example, a 3 inch by 3 inch cross-section and a 24 inch length or the like. The inner tube IT may have, for example, a 2.5 inch by 2.5 inch cross-section and a 6 inch length or the like. As shown in FIG. 5a, the inner and outer tubes IT,OT of the extrapter 150 overlap. The overlap may be 2 inches in length or the like. The thickness of the inner and outer tubes IT, OT may be 0.25 inches or similar. The tubes IT,OT may be connected at the overlap zone by welding, fasteners, adhesives, or the like.

As shown in FIG. 5b, in order to connect the extrapter 150 to the trailer adapter 102, the inner tube IT may be placed next to the hollow interior of the trailer adapter 102 and then extrapter 150 may be moved along the direction of the arrow toward the trailer adapter 102. As shown in FIG. 5c, the extrapter 150 may be attached to the trailer adapter 102 after moving the extrapter 150 so that the inner tube IT is inserted into the hollow interior of the trailer adapter 102. Typically, the inner tube IT of an extrapter 150 may be attached to the hollow interior of the trailer adapter 102 using a nut, bolt, and washer but other apparatus for attaching may be used, such as a pin and clip. As such, the inner tube IT and trailer adapter 102 may include apertures that pass completely through the inner tube IT and trailer adapter 102, respectively. The apertures may be 0.44 inches in diameter or the like with one aperture located on the outer tube OT 0.38 inches from the rear edge of the outer tube OT and another aperture located on the inner tube IT that is 0.84 inches from the plane of overlap between inner and outer tubes IT,OT. By aligning apertures, a bolt or pin may be positioned through the inner tube IT and trailer adapter 102 thereby facilitating the attachment of the extrapter 150 to the trailer adapter 102.

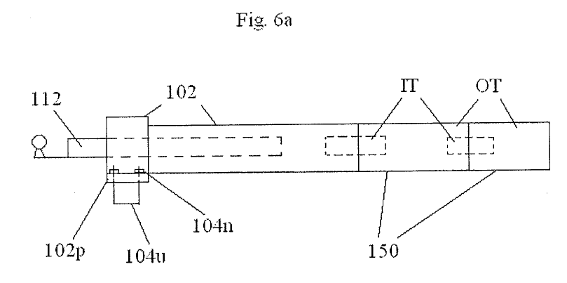

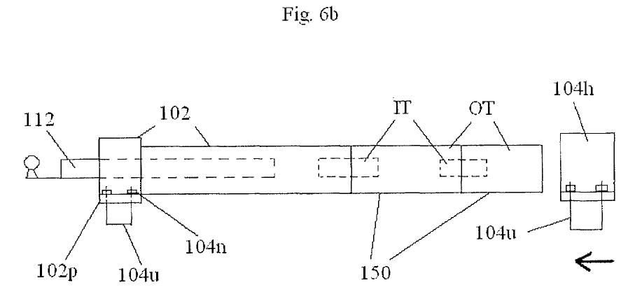

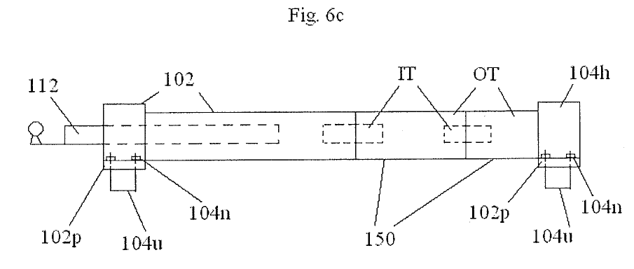

FIG. 6a shows an example of a hitch connector 100 with multiple extrapters 150 attached thereto. As shown in FIGS. 6b and 6c, a housing 104h of an attachment assembly 104 may be connected to a portion of an extrapter 150. In FIG. 6b, the housing 104h is positioned adjacent the end extrapter 150 and then moved along the arrow toward the end extrapter 150. As shown in FIG. 6c, after moving the housing 104h, as well as the rest of the attachment assembly, the housing 104h may be secured on the end extrapter 150. As discussed above, the housing 104h may be secured anywhere along an extrapter 150 or trailer adapter 102. Accordingly, the attachment assembly 104, which is attached to the extrapter 150 in FIG. 6c, may secure the trailer adapter 102 (via the extrapter 150) to a beam of the trailer frame that would otherwise be out of reach.

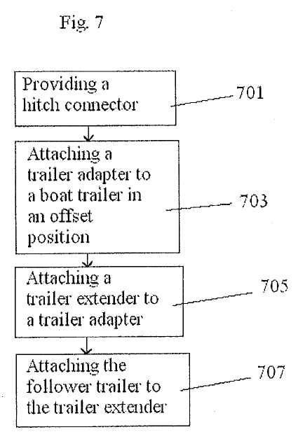

FIG. 7 shows a flowchart illustrating a method of securing a boat trailer to a follower trailer according to at least one embodiment of the present disclosure. In step 701 of the embodiment of the present disclosure shown in FIG. 7, a hitch connector is provided. As described above, a hitch connector may include a trailer adapter configured to be attached to a rear portion of the boat trailer in an offset position from the longitudinal centerline of the boat trailer and an attachment assembly for attaching the trailer adapter on the rear portion of the boat trailer. The hitch connector may further include a trailer extender configured to be secured to an end of the trailer adapter such that the trailer extender extends from the trailer adapter to beyond the rear portion of the boat trailer and based at least partially upon the positioning of the trailer adapter avoids the motor of a boat placed on the boat trailer and a securing assembly for securing the trailer extender to the trailer adapter.

In Step 703 of the embodiment of the present disclosure shown in FIG. 7, the trailer adapter is attached to the boat trailer in an offset position from the longitudinal centerline of the boat trailer. By offsetting the positioning of the adapter relative to the longitudinal centerline of the trailer frame, the hitch connector is able to avoid obstructions, such as those presented by boat motors, and attach to a follower trailer. In Step 705 of the embodiment of the present disclosure shown in FIG. 7, the trailer extender is attached to the trailer adapter with the trailer extender extending out from the rear of the boat trailer. In Step 707 of the embodiment of the present disclosure shown in FIG. 7, the follower trailer is attached to the trailer extender.

While the structure of the hitch connector apparatus and method of using a hitch connector apparatus described above may be used, other structural formulations and methods may be employed, such as welding the trailer adapter to the trailer frame, among other things.

The apparatus and methods have been presented in detail with reference to certain embodiments thereof; however, such embodiments are offered by way of non-limiting examples, as other versions are possible. It is anticipated that a variety of other modifications and changes will be apparent to those having ordinary skill in the art and that such modifications and changes are intended to be encompassed within the spirit and scope of the apparatus and methods as defined by the following claims.

What is claimed is:

1. An apparatus for pulling a follower trailer behind a boat trailer, the apparatus comprising:
a trailer adapter configured to be attached to a rear portion of the boat trailer in an offset position from the longitudinal centerline of the boat trailer;
at least one attachment assembly for attaching the trailer adapter on the rear portion of the boat trailer;
a trailer extender configured to be secured to an end of the trailer adapter such that the trailer extender extends from the trailer adapter to beyond the rear portion of the boat trailer and based at least partially upon the positioning of the trailer adapter avoids the motor of a boat placed on the boat trailer; and
a securing assembly for securing the trailer extender to the trailer adapter.

2. The apparatus of claim 1, wherein the attachment assembly comprises bolts that are substantially U-shaped.

3. The apparatus of claim 2, further comprising at least one plate attached to the trailer adapter, wherein each plate includes opposing broad, flat surfaces.

4. The apparatus of claim 3, wherein a first opposing surface of a plate is attached to the trailer adapter along an edge of each of the first opposing surface and trailer adapter.

5. The apparatus of claim 1, wherein the securing assembly comprises a pin and clip.

6. The apparatus of claim 1, further comprising at least one extrapter adapted to be secured to an end of the trailer adapter and configured to attach to a beam of the trailer adapter.

7. The apparatus of claim 1, wherein the trailer adapter is substantially hollow and the trailer extender is further configured to slide within the trailer adapter.

8. An apparatus for transporting objects on trailers, the apparatus comprising:
a boat trailer comprising a trailer frame having multiple boat contact portions configured to receive the hull of a boat, multiple no-contact portions configured to at least support the boat contact portions, and at least two opposing wheels with at least one wheel on either side of the longitudinal centerline of the boat trailer;
a follower trailer comprising a follower trailer frame, a tongue extending from a first portion of the follower trailer frame, and wheels on either side of the longitudinal centerline of the follower trailer; and
a hitch connector for connecting the boat trailer to the follower trailer, the hitch connector comprising:
a trailer adapter configured to be attached to a rear portion of the boat trailer in an offset position from the longitudinal centerline of the boat trailer;
at least one attachment assembly for attaching the trailer adapter on the rear portion of the boat trailer;
a trailer extender configured to be secured to an end of the trailer adapter such that the trailer extender extends from the trailer adapter to beyond the rear portion of the boat trailer and based at least partially upon the positioning of the trailer adapter avoids the motor of a boat placed on the boat trailer; and
a securing assembly for securing the trailer extender to the trailer adapter.

9. The apparatus of claim 8, wherein the attachment assembly comprises bolts that are substantially U-shaped.

10. The apparatus of claim 8, further comprising at least one plate attached to the trailer adapter, wherein each plate includes first and second opposing broad, flat surfaces.

11. The apparatus of claim 10, wherein the first opposing surface of a plate is attached to the trailer adapter along an edge of each of the first opposing surface and trailer adapter.

12. The apparatus of claim 11, wherein the securing assembly comprises a pin and clip.

13. The apparatus of claim 8, wherein the trailer adapter and trailer extender comprise hollow square cross-sections.

14. The apparatus of claim 13, wherein the trailer adapter and trailer extender comprise metal.

15. The apparatus of claim 14, wherein the tongue of the follower trailer is configured to attach to a hitch ball of the trailer extender.

16. The apparatus of claim 8, further comprising at least one extrapter adapted to be secured to an end of the trailer adapter and configured to attach to a beam of the trailer adapter.

17. A method of securing a boat trailer to a follower trailer, the method comprising:
providing a hitch connector, the hitch connector comprising:
a trailer adapter configured to be attached to a rear portion of the boat trailer in an offset position from the longitudinal centerline of the boat trailer;
at least one attachment assembly for attaching the trailer adapter on the rear portion of the boat trailer;
a trailer extender configured to be secured to an end of the trailer adapter such that the trailer extender extends from the trailer adapter to beyond the rear portion of the boat trailer and based at least partially upon the positioning of the trailer adapter avoids the motor of a boat placed on the boat trailer; and
a securing assembly for securing the trailer extender to the trailer adapter;
attaching the trailer adapter to the boat trailer in an offset position from the longitudinal centerline of the boat trailer;
attaching the trailer extender to the trailer adapter, wherein the extender extends out from the rear of the boat trailer; and
attaching a follower trailer to the trailer extender.

18. The method of claim 17, wherein attaching a trailer adapter to the boat trailer comprises securing U-shaped bolts to the boat trailer such that the trailer adapter is secured between the bolts and trailer.

19. The method of claim 17, further comprising attaching a second trailer adapter to the boat trailer and a second trailer extender to the second trailer adapter.

20. The method of claim 19, further comprising attaching a second follower trailer to the second trailer extender.
